(19) United States
(12) Patent Application Publication
(10) Pub. No.: US 2019/0361424 A1
(43) Pub. Date: Nov. 28, 2019

(54) MOTION EVALUATION METHOD, EVALUATION DEVICE, PARAMETER ADJUSTMENT METHOD USING SAID EVALUATION METHOD, WORKPIECE MACHINING METHOD, AND MACHINE TOOL

(71) Applicants: NATIONAL UNIVERSITY CORPORATION KOBE UNIVERSITY, Nada-ku, Kobe-shi, Hyogo (JP); MAKINO MILLING MACHINE CO., LTD., Meguro-ku, Tokyo (JP)

(72) Inventors: Ryuta SATO, Nada-ku, Kobe-shi, Hyogo (JP); Takumi NAKANISHI, Nada-ku, Kobe-shi, Hyogo (JP); Mitsunari ODA, Aikawa-machi, Aiko-gun, Kanagawa (JP); Nobu NAKAYAMA, Aikawa-machi, Aiko-gun, Kanagawa (JP)

(73) Assignees: NATIONAL UNIVERSITY CORPORATION KOBE UNIVERSITY, Nada-ku, Kobe-shi, Hyogo (JP); MAKINO MILLING MACHINE CO., LTD., Meguro-ku, Tokyo (JP)

(21) Appl. No.: 16/484,727

(22) PCT Filed: Feb. 5, 2018
(86) PCT No.: PCT/JP2018/003841

§ 371 Date: Aug. 8, 2019

(30) Foreign Application Priority Data
Feb. 10, 2017 (JP) 2017-023526

(51) Int. Cl. G05B 19/4068

(52) U.S. Cl. CPC G05B 19/4068; G05B 2219/37607; G05B 2219/35354

(57) ABSTRACT

In this motion evaluation method, which uses a circular motion test to evaluate motion characteristics of a numerically controlled machine tool, a normal direction change rate of a trajectory is calculated from a circular motion trajectory, the normal direction change rate of the trajectory is displayed in polar coordinates, and the motion characteristics of the numerically controlled machine tool are evaluated.

### FIELD

The present invention relates to a motion evaluation method for evaluating motion characteristics of a machine tool based on visual characteristics to a person, an evaluation device, and a workpiece machining method and machine tool using the evaluation method.

### BACKGROUND

When machining is performed by a numerically controlled machine tool, unwanted streak-like machining marks may appear on the machined surface, due to trajectory errors at quadrant glitches or steps that occur when the motion direction of the feed axis is reversed. Trajectory errors at quadrant glitches and steps can be reduced by appropriately setting the controller parameters of the controller. Patent Literature 1 discloses a method for adjusting numerical controller parameters based on measurement results of circular motion trajectory. Furthermore, Patent Literature 1 describes performing circular motion test, and adjusting parameters so as to minimize trajectory errors.

### CITATION LIST

### Patent Literature

[PTL 1] Japanese Unexamined Patent Publication (Kokai) No. 2009-80616

### Non Patent Literature

[NPL 1] JIS B6190-4: Machine Tool Test Method Standards Part 4: Circular motion test by Numerical Control

### SUMMARY

### Technical Problem

The present invention aims to provide a motion evaluation method and evaluation device for evaluating motion characteristics of a numerically controlled machine tool based on characteristics which are visible to a person, and to provide a workpiece machining method and machine tool in which parameters are adjustable based on such evaluation.

### Solution to Problem

In order to achieve the above object, the present invention provides a motion evaluation method for evaluating a motion characteristic of a numerically controlled machine tool using a circular motion test, the method comprising the steps of calculating a normal direction change rate of a trajectory from a circular motion trajectory, and displaying the normal direction change rate of the trajectory as polar coordinates.

The present invention further provides a motion evaluation device for evaluating a motion characteristic of a numerically controlled machine tool from a circular motion test, the device comprising a normal direction change rate calculation unit for calculating a normal direction change rate from motion trajectory data when a spindle of a machine tool moves circularly, a visible limit data storage unit for storing data related to a limit normal direction change rate at which a shape change can be visually recognized by a person, a polar coordinate change unit for changing the normal direction change rate calculated by the normal direction change rate calculation unit to polar coordinate data, and a display unit for displaying, as polar coordinates, the normal direction change rate which was changed to polar coordinate data along with a visible limit of the visible limit data storage unit.

The present invention further provides a workpiece machining method, comprising the steps of feeding a spindle along a predetermined circumference within a predetermined plane and calculating a normal direction change rate of a trajectory from a circular motion trajectory of the spindle, displaying the normal direction change rate of the trajectory as polar coordinates, and changing a control parameter of the machine tool so as to make a maximum value of the normal direction change rate of the trajectory not greater than a predetermined value.

The present invention further provides a machine tool including an orthogonal at least three-axis feed device, and which machines a workpiece by moving a tool mounted on a spindle and the workpiece relative to each other, the machine tool comprising a normal direction change rate calculation unit for calculating a normal direction change rate from motion trajectory data when a spindle of a machine tool moves circularly, a visible limit data storage unit for storing data related to a limit normal direction change rate at which a shape change can be visually recognized by a person, a polar coordinate change unit for changing the normal direction change rate calculated by the normal direction change rate calculation unit to polar coordinate data, a display unit for displaying, as polar coordinates, the normal direction change rate which was changed to polar coordinate data along with a visible limit of the visible limit data storage unit, and a parameter change unit for changing a control parameter of the machine tool so as to make a maximum value of the normal direction change rate of the trajectory not greater than a predetermined value.

### Advantageous Effects of Invention

According to the present invention, a method for evaluating an object surface based on visual characteristics to a person, an evaluation device, and a workpiece machining method and machine tool using the evaluation method can be provided. Furthermore, according to the present invention, it can be easily judged whether or not streak-like machining marks on a machined surface are visible to a person, the effect of which is significant.

### BRIEF DESCRIPTION OF DRAWINGS

FIG. 1 is a block diagram of a machine tool motion evaluation device according to a preferred embodiment of the present invention.

FIG. 2 is a schematic view showing examples of circular motion trajectory.

FIG. 3 is a view showing a cylindrical machined surface near 90°.

FIG. 4 is a view detailing a method for determining a normal direction change rate.

FIG. 5 is a view detailing a method for determining an angle of a normal direction from coordinate information.

FIG. 6 is a view detailing a method for evaluating the motion of a machine tool from the normal direction change rate.

FIG. 7 is a block diagram showing an application example of a motion evaluation device according to the present invention.

FIG. 8 is a block diagram showing another application example of a motion evaluation device according to the present invention.

FIG. 9 is a view showing the effects of adjustment of control parameters of a machine tool by a parameter adjustment method according to the present invention.

FIG. 10 is a view showing a cylindrical machined surface near 90° when the control parameters of the machine tool according to the present invention have been adjusted.

### DESCRIPTION OF EMBODIMENTS

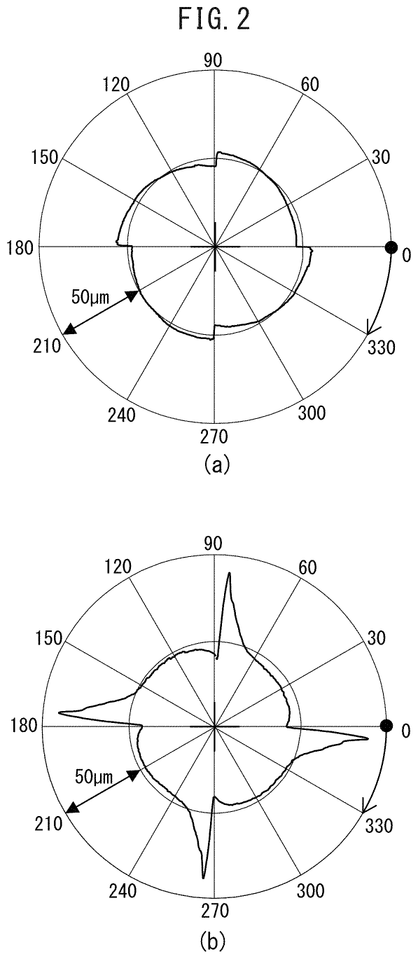

Quadrant glitches and step-like machining marks occur when the motion direction of a feed axis is reversed such as along a cylindrical surface or in a circumferential groove using a machine tool comprising an at least three-axis feed device which machines a workpiece by moving a tool mounted on a spindle and a workpiece relative to each other. Non-Patent Literature 1 defines a circular motion test by numerical control accompanied by such feed axis reversal. The circular motion test results are evaluated by enlarging the radial error of the circular motion trajectory. Examples of circular motion trajectory measurement results are shown in FIG. 2.

FIG. 2(a) shows step-like trajectory errors of about 5 micrometers which occur at the time of quadrant switching in which each feed axis is reversed. FIG. 2(b) shows protrusion-like trajectory errors (quadrant glitches) of about 50 micrometers which occur at the time of quadrant switching in which each feed axis is reversed. Conventionally, parameters are adjusted so as to minimize trajectory errors to the greatest extent possible. Specifically, the trajectory shown in FIG. 2(a) is more preferable than the trajectory shown in FIG. 2(b).

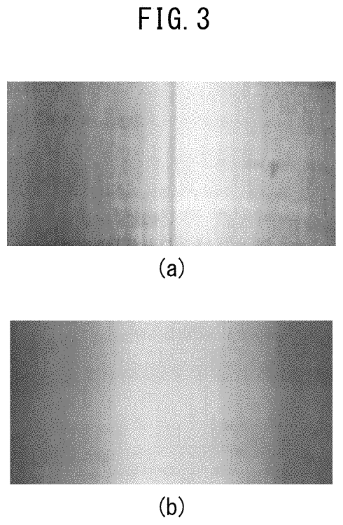

These trajectory errors appear as streak-like machining marks on the machined surface. FIG. 3 shows the results of photography of a machined surface in which trajectory errors have occurred in the vicinity of 90° when cylindrical machining is performed using a peripheral blade of a square end mill under conditions identical to those measured for the motion trajectories of FIG. 2. With reference to FIG. 3, while clear streak-like machining marks appear in FIG. 3(a), in which the trajectory errors are small, machining marks cannot be observed in FIG. 3 (b). Thus, from the viewpoint of the appearance of the machined surface, the trajectory shown in FIG. 2(b) is more preferable than the trajectory shown in FIG. 2(a). In the conventional evaluation method and adjustment method, the appearance of the machined surface is not considered in the evaluation results, and adjustment of the parameters does not necessarily reduce the appearance of defects.

The preferred embodiments of the present invention for solving such problems will be described below with reference to the attached drawings.

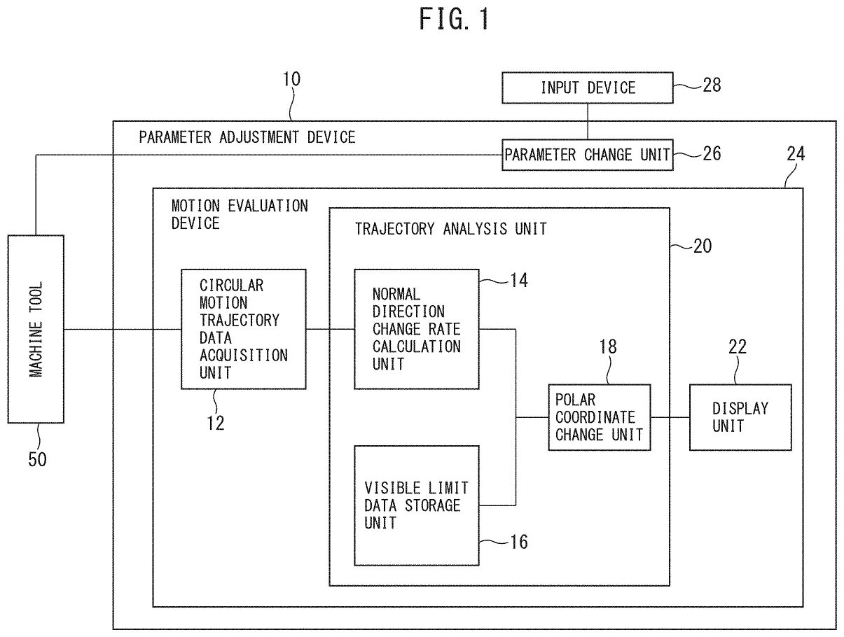

With reference to FIG. 1, the parameter adjustment device 10, as the object surface evaluation device of the present invention, comprises a motion evaluation device 24, and a parameter change unit 26. The motion evaluation device 24 comprises, as primary constituent elements, a circular motion trajectory data acquisition unit 12, a trajectory analysis unit 20 including a normal direction change rate calculation unit 14, a visible limit data storage unit 16 and a polar coordinate change unit 18, and a display unit 22. The trajectory analysis unit 20 can be constituted by a CPU, RAM, ROM, hard disk, SSD, bidirectional busses for connecting these components, and relevant programs. The display unit 22 can be constituted by a liquid crystal panel or a touch panel.

The circular motion trajectory data acquisition unit 12, as will be described later, acquires circular motion trajectory data or coordinate values of the feed axes from the NC device of the machine tool 50 when spindle of the machine tool 50 undergoes in-plane circular motion. Alternatively, the circular motion data may be obtained by performing cylindrical machining on a workpiece and measuring the shape thereof using a roundness measurement instrument or the like.

Furthermore, the parameter change unit 26 changes the control parameters of the machine tool 50 in accordance with commands input by the operator via the input device 28. The input device 26 can be, for example, a keyboard, a mouse, or alternatively, can be the touch panel constituting the display unit 22.

In general, a person can visually recognize a shape change in portions in which the normal direction change rate of the object surface is large, and a person cannot visually recognize a shape change in portions in which the normal direction change rate is small. The limits of normal direction change rate at which a person can visually recognize shape change are stored in the visible limit data storage unit 16. These limits of normal direction change rate at which a person can visually recognize shape change can be obtained by preparing a plurality of test pieces having a plurality of different known normal direction change rates, determining whether the shape change can be visually recognized by a plurality of observers, and averaging the normal direction change rates at that time.

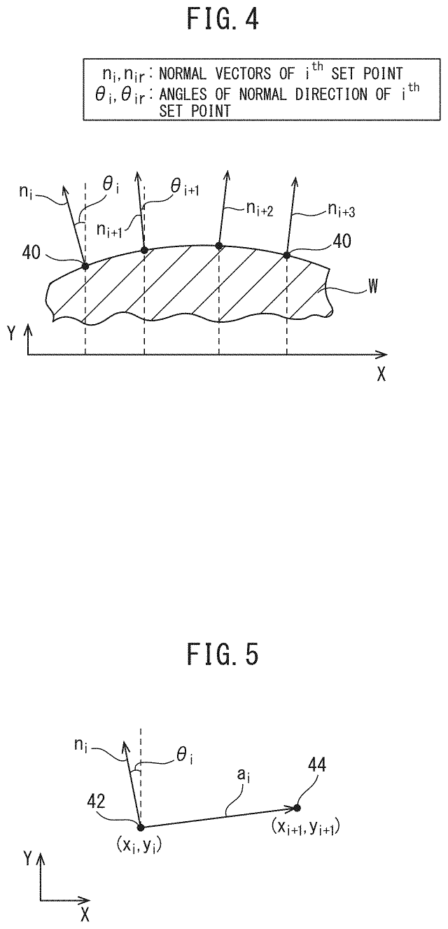

The normal direction change rate calculation unit 14 calculates the normal direction change rate of the circular motion trajectory of the machine tool 50 based on the circular motion trajectory data from the circular motion trajectory data acquisition unit 12. The normal direction change rate will be described with Reference to FIGS. 4 and 5. The circular motion trajectory data from the circular motion trajectory data acquisition unit 12 includes two-dimensional coordinate values. The example shown in FIG. 4 is partial cross-sectional view in which a cylindrical workpiece W has been cut along the plane (XY plane) perpendicular to the Z-axis. Normal vectors can be set at predetermined intervals on the surface of the workpiece W. The workpiece W is cut at predetermined intervals along the XY plane. By setting normal vectors at predetermined intervals in each cutting plane, it is possible to evaluate the entire surface of the workpiece W.

Set points 40 are set at predetermined intervals along the machined surface of the workpiece W. Next, at the set points 40, normal vectors nᵢ perpendicular to the surface inclination are set. The normal vectors nᵢ are normal vectors of the i^{th} set point 40. Angles θᵢ with respect to the normal direction can be set for the normal vectors nᵢ. The angle relative to the Y-axis is set as the normal direction angle θᵢ.

In FIG. 5, the coordinate values of the i^{th} set point 42 and the (i+1)^{th} set point 44 are known. A vector aᵢ can be set based on the coordinate values of these two set points 42, 44. The vector aᵢ is the vector from set point 42 toward set point 44. The vector perpendicular to vector aᵢ can be set as the normal vector nᵢ. The normal direction angle θᵢ at this time can be calculated from the following formula (1). The normal direction angle θᵢ for the i^{th} set point of the machined surface can be calculated in this manner.

$$\begin{matrix}[ Formula 1 ] & \\ {θ}_{i} = {tan}^{- 1} \frac{( {y}_{i + 1} - {y}_{i} )}{( {x}_{i + 1} - {x}_{i} )} & ( 1 )\end{matrix}$$

θᵢ is the normal direction angle at the i^{th} set point

The normal direction change rate calculation unit 14 calculates the normal direction change rate at the set point 40. The normal direction change rate is the rate of change of the angle of the normal direction of mutually adjacent set points. An example thereof is the change rate from the normal direction angle θᵢ to the normal direction angle θᵢ+1. The normal direction change rate can be calculated from the following formula (2). The following formula (2) represents the normal direction change rate at the i^{th} set point 40 of the design shape. The normal direction change rate of the evaluation target shape can also be calculated by the same method. Note that it is geometrically clear that the normal direction change rate is the same as the change rate in the direction tangential to the machined surface.

$$\begin{matrix}[ Formula 2 ] & \\ \frac{d {θ}_{i}}{dx} = ( \frac{{θ}_{( i + 1 )} - {θ}_{i}}{{x}_{( i + 1 )} - {x}_{i}} ) & ( 2 )\end{matrix}$$

dθᵢ/dx is the normal direction change rate

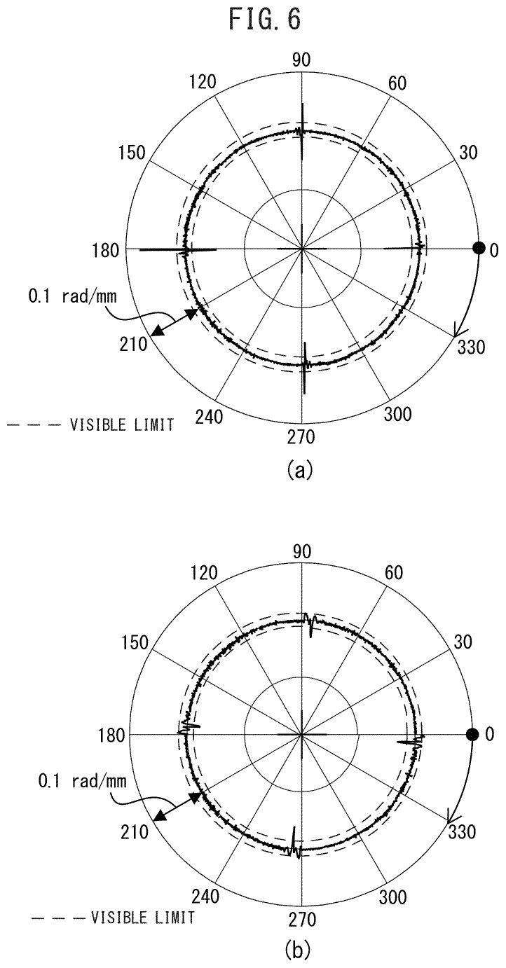

The polar coordinate change unit 18 changes the normal direction change rate obtained in this manner to polar coordinates, and transmits the change rate to the display unit 22 along with the visible limit values of the normal direction change rate stored in the visible limit data storage unit 16. FIG. 6 shows the calculation results of the normal direction change rate calculation unit 14 displayed on the display unit 22.

In FIG. 6, the visible limit values of the normal direction change rate are represented by dashed lines. FIGS. 6(a) and 6(b) correspond to FIGS. 2(a) and 2(b) and FIGS. 3(a) and 3(b). Note that the normal direction change rate of the trajectory is obtained by extracting only spatial frequency components which are visually recognizable by a person from a geometric normal direction change rate of the trajectory. The range of spatial frequency components which are visually recognizable by a person may be determined based on an ophthalmologic contrast sensitivity curve or may be determined using a shape separately prepared for evaluation.

Further, in the drawings, the separately evaluated human normal direction change rate visual recognition limit is also represented by a dashed line. When FIG. 6(a) and FIG. 6(b) are compared with each other, a greater normal direction change rate occurs in FIG. 6(a), and even if the error of the circular motion trajectory shown in FIG. 2(a) is smaller than that of the circular motion trajectory shown in FIG. 2(b), specifically, even if the machining accuracy is high, clear machining marks occur as shown in FIG. 3(a). Thus, according to the motion evaluation device 24, the motion evaluation method of the present invention enables motion evaluation corresponding to the appearance of the machined surface by causing the machine tool 50 to perform circular motion and acquiring the trajectory data thereof prior to machining.

Furthermore, the operator of the machine tool 50 refers to the normal direction change rate displayed on the display unit 22, and when there is a normal direction change rate which is equal to or greater than the visually recognizable limit, the operator corrects the control parameters of the machine tool via the input device 28 and the parameter change unit 26, and repeats this process until the normal direction change rate is equal to or less than the visually recognizable limit. The adjustment target control parameters include position loop gain, speed loop gain, speed loop integral gain or time constant, friction compensation parameters, and backlash correction parameters.

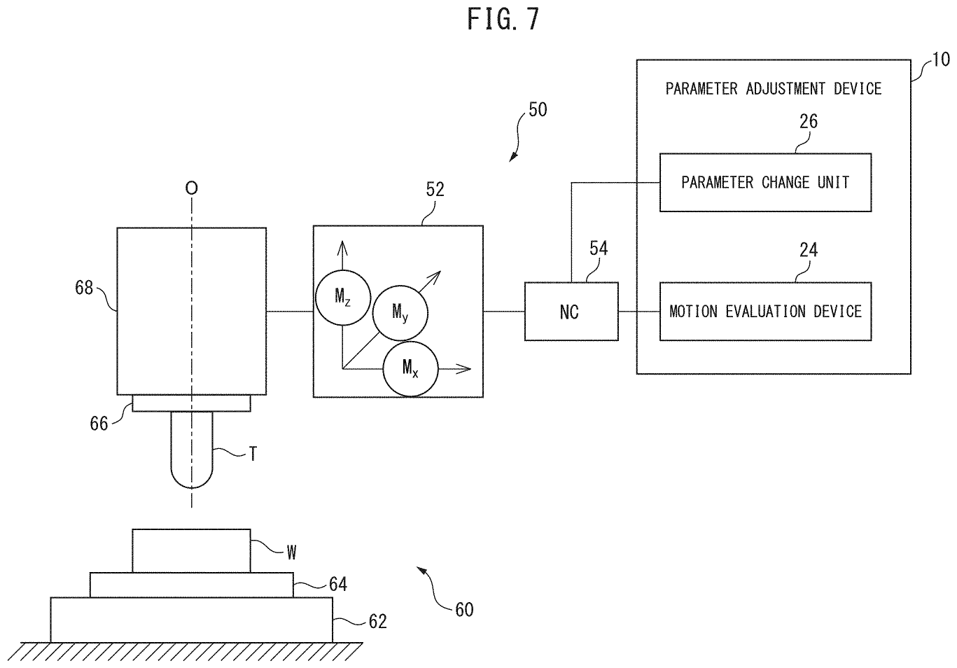

Next, an application example of the parameter adjustment device 10 of the present invention will be described with reference to FIG. 7. In the example shown in FIG. 7, the circular motion trajectory data acquisition unit 12 is constituted by the NC device of the machine tool 50. In the machine tool 50 of FIG. 7, the parameter adjustment device 10 is combined with the machining device 60. The machining device 60 comprises, as primary constituent elements, a bed 62 as a base secured to the floor of a factory, a table 64 which is attached to the upper surface of the bed 62 and on an upper surface of which the workpiece W is secured, a spindle head 68 which supports a spindle 66, on a tip of which a tool T facing the workpiece W secured to the bed 62 is mounted, so as to be rotatable around a vertical axis of rotation O, a drive mechanism 52 for reciprocally driving the spindle head 68 in the X-axis, Y-axis, and Z-axis orthogonal directions relative to the bed 62, and an NC device 54 for controlling the servomotors of the drive mechanism 52.

The drive mechanism 52 comprises, for example, X-axis, Y-axis, and Z-axis ball screws (not illustrated), nuts (not illustrated) for engagement with the ball screws, X-axis, Y-axis, and Z-axis drive motors Mx, My, and Mz consisting of servomotors connected to one end of each of the X-axis, Y-axis, and Z-axis ball screws for rotationally driving the X-axis, Y-axis, and Z-axis ball screws. Furthermore, in addition to the three orthogonal feed axes of X-, Y-, and Z-axes, the machine tool 50 may include one or more rotational feed axes such as an A-axis for rotationally feeding about the X-axis in the horizontal direction, or a C-axis for rotationally feeding about the Z-axis in vertical direction. In such a case, in addition to the X-axis, Y-axis, and Z-axis drive motors Mx, My, and Mz, the drive mechanism 52 may include servomotors for the rotational feed axes such as the A-axis and C-axis.

The machining device 60 is provided with digital scales (not illustrated) for detecting the positions of the X-, Y-, and Z-feed axes, and the position of each of the feed axes is fed back to the NC device 54. The circular motion trajectory data acquisition unit 12 of the motion evaluation device 24 receives trajectory data from the NC device 54 when the spindle 66 of the machining device 60 undergoes circular motion in the XY plane.

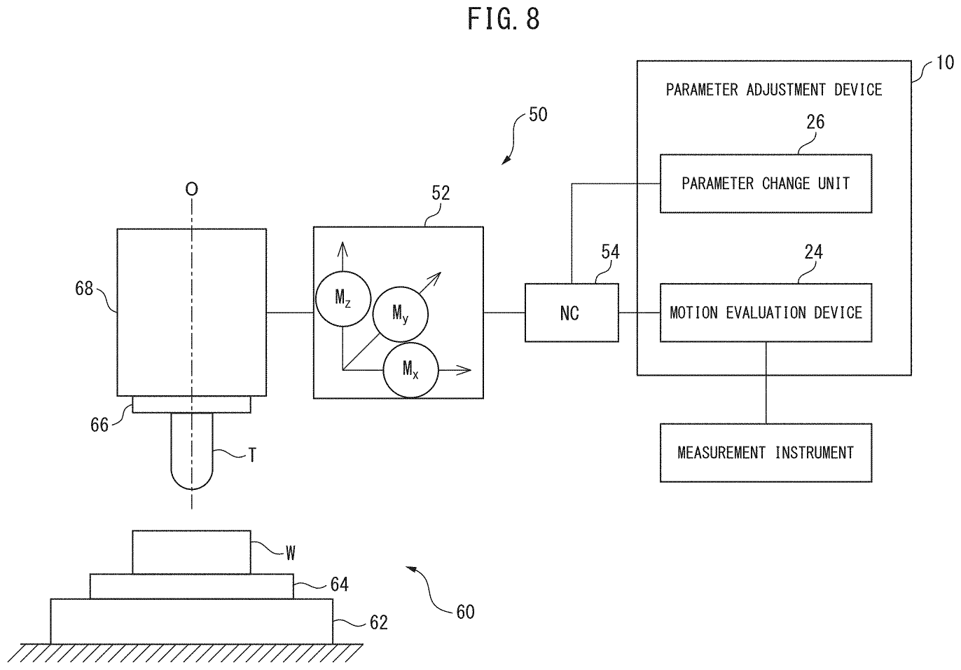

Next, another application example of the parameter adjustment device 10 of the present invention will be described with reference to FIG. 8. In the example shown in FIG. 8, the machine tool 50 comprises a measurement instrument 80 such as a ball bar gauge or a cross-grid scale. In the example of FIG. 8, the circular motion trajectory data acquisition unit 12 receives trajectory data from the NC device 54 when the spindle 66 of the machining device 60 undergoes circular motion in the XY plane.

In the configurations of FIGS. 7 and 8, the parameter adjustment device 10 can be incorporated as a part of the control program of the machine controller (not illustrated) of the machining device 60 or the NC device 54. In this case, the display unit 22 and the input device 26 can be constituted by the touch panel (not illustrated) provided on the control panel (not illustrated) of the machining device 60.

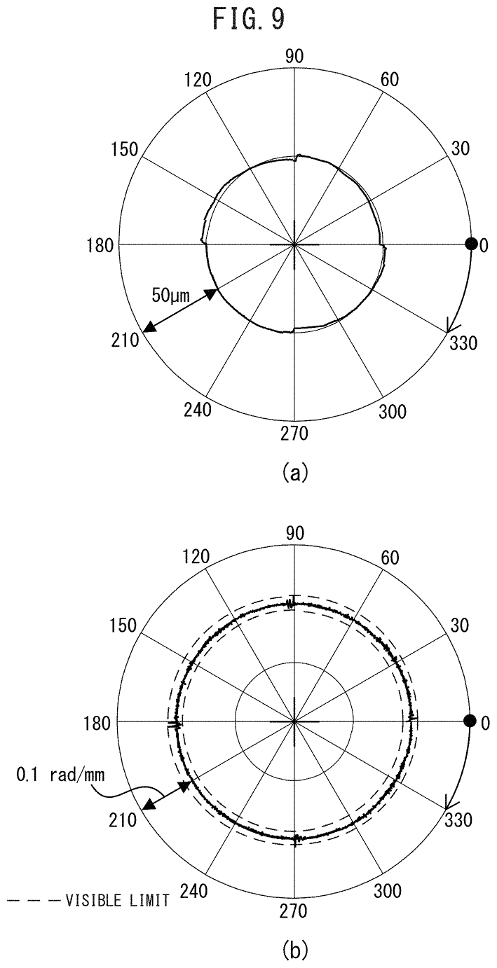

FIG. 9 shows an example in which the adjustment method according to the present invention is applied. FIG. 9(a) is circular motion trajectory display results according to the prior art, and FIG. 9(b) is display results according to the present invention. As shown in FIG. 9(b), according to the present invention, the normal direction change rate of the trajectory is equal to or less than the human visually recognizable limit represented by the dashed line. The normal direction change rate of the trajectory is obtained by extracting only spatial frequency components which are visually recognizable by a person from a geometric normal direction change rate of the trajectory.

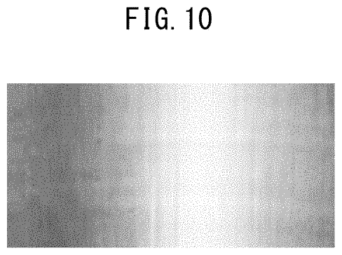

FIG. 10 shows the results of photography of a machined surface in which trajectory errors have occurred in the vicinity of 90° when cylindrical machining is performed using a peripheral blade of a square end mill under conditions identical to those measured for the motion trajectories of FIG. 9. According to FIG. 10, there are no visible streak-like machining marks on the machined surface, and it can be seen that a machined surface without visual defects can be obtained using the parameter adjustment method according to the present invention.

Furthermore, though examples in which the normal direction change rate is calculated from a circular motion trajectory have been described in the embodiments described above, the present invention is not limited thereto. For example, equivalents of the normal direction change rate, such as the tangential change rate of the trajectory or the derivative value of the trajectory itself are encompassed by the present invention.

### REFERENCE SIGNS LIST

10 parameter adjustment device
12 circular motion trajectory data acquisition unit
14 normal direction change rate calculation unit
16 visible limit data storage unit
18 polar coordinate change unit
20 trajectory analysis unit
22 display unit
24 motion evaluation device
26 parameter change unit
28 input device
40 set point
42 set point
44 set point
50 machine tool
52 drive mechanism
54 NC device
60 machining device
62 bed
64 table
66 spindle
68 spindle head
80 measurement instrument

1. A motion evaluation method for evaluating a motion characteristic of a numerically controlled machine tool using a circular motion test, the method comprising the steps of:
calculating a normal direction change rate of a trajectory from a circular motion trajectory, and
displaying the normal direction change rate of the trajectory as polar coordinates.

2. The method according to claim 1, wherein the normal direction change rate of the trajectory is obtained by extracting only spatial frequency components which are visually recognizable by a person from a geometric normal direction change rate of the trajectory.

3. The method according to claim 1, wherein the normal direction change rate is displayed as polar coordinates along with a limit normal direction change rate at which a shape change can be visually recognized by a person.

4. A motion evaluation device for evaluating a motion characteristic of a numerically controlled machine tool from a circular motion test, the device comprising:
a normal direction change rate calculation unit for calculating a normal direction change rate from motion trajectory data when a spindle of a machine tool moves circularly,
a visible limit data storage unit for storing data related to a limit normal direction change rate at which a shape change can be visually recognized by a person,
a polar coordinate change unit for changing the normal direction change rate calculated by the normal direction change rate calculation unit to polar coordinate data, and
a display unit for displaying, as polar coordinates, the normal direction change rate which was changed to polar coordinate data along with a visible limit of the visible limit data storage unit.

5. The device according to claim 4, wherein the normal direction change rate of the trajectory is obtained by extracting only spatial frequency components which are visually recognizable by a person from a geometric normal direction change rate of the trajectory.

6. A parameter adjustment method for evaluating a motion characteristic of a numerically controlled machine tool using a circular motion test and adjusting a parameter of a controller, the method comprising the steps of:
calculating a normal direction change rate of a trajectory from a circular motion trajectory,
displaying the normal direction change rate of the trajectory as polar coordinates, and
adjusting a control parameter of the machine tool so as to make a maximum value of the normal direction change rate of the trajectory not greater than a predetermined value.

7. The method according to claim 6, wherein the normal direction change rate of the trajectory is obtained by extracting only spatial frequency components which are visually recognizable by a person from a geometric normal direction change rate of the trajectory.

8. The method according to claim 7, wherein the normal direction change rate is displayed as polar coordinates along with a limit normal direction change rate at which a shape change can be visually recognized by a person.

9. A workpiece machining method, comprising the steps of:
feeding a spindle along a predetermined circumference within a predetermined plane and calculating a normal direction change rate of a trajectory from a circular motion trajectory of the spindle,
displaying the normal direction change rate of the trajectory as polar coordinates, and
changing a control parameter of the machine tool so as to make a maximum value of the normal direction change rate of the trajectory not greater than a predetermined value.

10. The method according to claim 9, wherein the normal direction change rate of the trajectory is obtained by extracting only spatial frequency components which are visually recognizable by a person from a geometric normal direction change rate of the trajectory.

11. The method according to claim 9, wherein the normal direction change rate is displayed as polar coordinates along with a limit normal direction change rate at which a shape change can be visually recognized by a person.

12. A machine tool including an orthogonal at least three-axis feed device, and which machines a workpiece by moving a tool mounted on a spindle and the workpiece relative to each other, the machine tool comprising:
a normal direction change rate calculation unit for calculating a normal direction change rate from motion trajectory data when a spindle of a machine tool moves circularly,
a visible limit data storage unit for storing data related to a limit normal direction change rate at which a shape change can be visually recognized by a person,
a polar coordinate change unit for changing the normal direction change rate calculated by the normal direction change rate calculation unit to polar coordinate data,
a display unit for displaying, as polar coordinates, the normal direction change rate which was changed to polar coordinate data along with a visible limit of the visible limit data storage unit, and
a parameter change unit for changing a control parameter of the machine tool so as to make a maximum value of the normal direction change rate of the trajectory not greater than a predetermined value.

13. The machine tool according to claim 12, wherein the normal direction change rate of the trajectory is obtained by extracting only spatial frequency components which are visually recognizable by a person from a geometric normal direction change rate of the trajectory.

14. The machine tool according to claim 12, wherein the normal direction change rate is displayed as polar coordinates on the display unit along with a limit normal direction change rate at which a shape change can be visually recognized by a person.
